(19) United States
(12) Patent Application Publication
(10) Pub. No.: US 2025/0291100 A1
(43) Pub. Date: Sep. 18, 2025

(54) OPTICAL MATERIAL ENCAPSULATED DIFFRACTIVE GRATINGS

(71) Applicant: GOOGLE LLC, Mountain View, CA (US)

(72) Inventors: Thomas Hoekman, Redwood City, CA (US); Joseph Daniel Lowney, Tucson, AZ (US)

(21) Appl. No.: 18/608,474

(22) Filed: Mar. 18, 2024

(51) Int. Cl. F21V 8/00; G02B 27/01

(52) U.S. Cl. CPC G02B 6/0016; G02B 6/0036; G02B 6/0065; G02B 27/0172; G02B 2027/0178

(57) ABSTRACT

A head-worn display includes a lightguide having grating structures configured to direct received light based one or more physical parameters of the grating structures. To modify how the grating structures of the lightguide direct light, the lightguide includes an optical material that at least partially encapsulates the grating structures. This optical material at least partially encapsulates the grating structures such that a fraction of received light based on the refractive index of the optical material is received by the grating structures. The grating structures then direct the fraction of light based on the physical parameters of the grating structures at a diffraction efficiency based on the refractive index of the optical material.

### BACKGROUND

Lightguides, such as those used in head-worn displays (HWDs), are commonly configured to direct light representative of an image from a projector to the eye of a user such that the image is viewable to the user in a real-world space. To this end, some lightguides include an incoupler and an outcoupler each having sets of diffractive grating structures that are configured to direct light based on various parameters such as the angle, height, and duty cycle of the grating structures. For example, within some lightguides, the incoupler of a lightguide is configured to first receive light representing an image emitted from a projector. This incoupler includes a set of grating structures having parameters such that the incoupler directs the light into the main body of the lightguide which causes the light to propagate through the body of the lightguide toward an outcoupler. This outcoupler includes another set of grating structures having parameters such that the outcoupler directs the received light out of the lightguide and toward the eyes of a user. The light directed by the outcoupler then forms an exit pupil near the eyes of the user, allowing the user to view the image represented by the light in a real-world space.

Due to the sets of grating structures of a lightguide directing light based on the parameters of the grating structures, changing how a set of grating structures directs light requires modifying one or more parameters of the grating structures. However, modifying the parameters of the grating structures requires fabricating a new set of grating structures with the modified parameters. As such, modifying the parameters of the grating structures to compensate for manufacturing tolerances, manufacturing errors, design changes, and the like requires new sets of grating structures to be fabricated, increasing the cost and time needed to manufacture lightguides including these sets of grating structures.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a diagram of an example display system housing a projection system including a lightguide configured to direct light based on a deposited optical material, in accordance with some embodiments.

FIG. 2 is a diagram illustrating a projection system that projects images directly onto the eye of a user using a lightguide configured to direct light based on a deposited optical material, in accordance with some embodiments.

FIG. 3 is a diagram illustrating an example lightguide exit pupil expansion system, in accordance with some embodiments.

FIG. 4 is a diagram of a lightguide having a deposited optical material, in accordance with some embodiments.

FIG. 5 is a diagram of a lightguide having zones of deposited optical material, in accordance with some embodiments.

FIG. 6 is a diagram of a lightguide having a set of diffractive gratings with a deposited protective material and a deposited optical material, in accordance with embodiments.

FIG. 7 is a diagram of a lightguide having a deposited optical material that forms a surface of the lightguide, in accordance with some embodiments.

FIG. 8 is a diagram of a lightguide having a deposited optical material that forms a surface of the lightguide having one or more patterns, in accordance with some embodiments.

FIG. 9 is a flow diagram of an example method for manufacturing a lightguide having a deposited optical material, in accordance with embodiments.

FIG. 10 is a diagram illustrating a partially transparent view of a head-worn display (HWD) that includes a projection system, in accordance with some embodiments

### DETAILED DESCRIPTION

Systems and techniques herein are directed to head-worn displays (HWDs) (e.g., extended reality HWDs) configured to direct light toward the eyes of a user such that one or more extended reality (XR) images are presented to the user. For example, an HWD has a form resembling eyeglasses and includes one or more lenses containing a lightguide to direct light representative of an image to the eye of the user. Herein, the combination of the lens and lightguide is referred to as an “optical combiner,” “optical combiner lens,” or both. Such a lightguide, for example, includes one or more incouplers, exit pupil expanders (EPEs), and outcouplers configured to direct light representing an XR image from a projector to the eye of the user. As an example, the lightguide includes an incoupler configured to receive light representing an XR image emitted from a light engine and direct the received light into the lightguide such that the light propagates through the lightguide using total internal reflection (TIR), partial internal reflection (PIR), or both. The light then propagates through the lightguide until the light is received at an outcoupler of the lightguide. In response to receiving the light, the outcoupler directs the light out of the lightguide and towards the eye of the user such that the light forms an exit pupil representative of the XR image near the eye of the user. This exit pupil, for example, represents the location along the optical path where the beams of the light, as directed by the lightguide, intersect. Further, some lightguides include an exit pupil expander (EPE) configured to receive light from the incoupler and direct light towards the outcoupler. Such an EPE, for example, is further configured to direct the light toward the outcoupler such that the size of the exit pupil is increased (e.g., the exit pupil is expanded).

To direct light representative of an XP image received from a projector, each incoupler, EPE, and outcoupler of the lightguide is formed from a respective set of diffractive grating structures. These sets of diffractive grating structures, for example, are disposed on a surface of the lightguide and are configured to direct light (e.g., diffract light) based on the physical parameters of the diffractive grating structures within the set of diffractive grating structures. That is to say, a set of diffractive grating structures is configured to direct light in a dispersion pattern and at a diffraction efficiency based on the physical parameters of the diffractive grating structures within the set of diffractive grating structures. A diffraction grating structure includes, for example, a Bragg grating structure, surface-relief grating structure, polarization volume grating structure, volumetric holographic grating structure, mirror, reflective facet, and the like. Additionally, physical parameters of the diffractive grating structures within a set of diffractive grating structures include, as an example, the angle relative to a surface, the duty cycle, the period, the height, the width, or any combination of the diffractive grating structures. As an example, a set of diffractive grating structures forming an incoupler of a lightguide includes diffractive grating structures having one or more parameters (e.g., angles, period) that cause the grating structures to direct received light into a body of the lightguide.

While fabricating a lightguide including such sets of diffractive grating structures, certain conditions arise requiring how a set of diffractive grating structures directs light to be modified (e.g., requiring the diffraction efficiency of the set of diffractive grating structures to be modified). For example, in response to certain tolerances in the manufacturing process of a lightguide, one or more components of a lightguide (e.g., incoupler, EPE, outcoupler, body) deviate from a desired function (e.g., one or more components of the lightguide disperse light differently than intended). To compensate for these deviations, the diffraction efficiencies of one or more sets of diffractive grating structures are modified such that the lightguide functions as intended. As another example, certain characteristics or parameters for a set of diffractive grating structures increase the chance of introducing deformities in one or more components of the lightguide during the manufacturing processes such as air bubbles, working stamp damage, or the like. Such deformities in the components of the lightguide prevent these components from operating as intended. To compensate for these deformities, the diffraction efficiencies at which one or more sets of diffractive grating structures direct light are modified such that the lightguide operates as desired.

However, because a set of diffractive grating structures is configured to direct light based on the physical parameters (e.g., angle, depth, period) of the diffractive grating structures in the set of diffractive grating structures, modifying how a set of diffractive gratings directs light (e.g., modifying the diffraction efficiency) requires changing one or more parameters of the diffractive grating structures. To change these physical parameters, the diffractive grating structures must be refabricated with the modified parameters, which increases the time and cost required to fabricate the lightguide. To this end, systems and techniques disclosed herein are directed to a lightguide including a deposited optical material configured to modify how a set of diffractive grating structures directs received light (e.g., to modify the diffraction efficiency at which a set of diffractive grating structures directs received light). For example, such a lightguide includes a substrate having opposing surfaces that is formed from an effectively transparent material so as to allow a user to view a real-world space in front of the user. Deposed on a first surface of this substrate is a set of diffractive grating structures having one or more predetermined parameters based on a pattern of a master stamp, such as predetermined angles, predetermined duty cycles, predetermined periods, predetermined heights, and the like. Additionally, the lightguide includes an optical material deposited on the first surface of the substrate such that one or more diffractive grating structures of the set of diffractive grating structures are at least partially encapsulated by the optical material. Such an optical material, for example, has a predetermined refractive index that causes a fraction of the light received by the optical material to be diffracted at an angle based on the predetermined refractive index. As an example, the optical material includes a refractive index that causes a fraction of light received by the optical material to be directed toward the set of diffractive grating structures, a surface of the lightguide, or both such that the fraction of light is incident upon a surface of the lightguide, the diffractive grating structures of the set of diffractive grating structures, or both at a predetermined angle. The surfaces of the lightguide, the set of diffractive grating structures, or both then direct the received fraction of light based on one or more parameters of the diffractive grating structures, the predetermined angle upon which the received light is incident, or both.

In this way, a lightguide allows how a set of diffractive grating structures directs light to be modified without changing the physical parameters of the diffractive grating structures. That is to say, the lightguide allows for the diffractive index of a set of diffractive gratings to be modified without changing the physical parameters of the diffractive grating structures. For example, rather than change one or more physical parameters of the diffractive grating structures to modify the fraction of received light which a set of diffractive grating structures directs into different diffraction orders, an optical material with a refractive index that causes the set of diffractive grating structures to distribute light into diffraction orders with a desired fraction is deposited over the set of diffractive grating structures. In other words, an optical material that causes a desired fraction of received light to be diffracted into a corresponding diffraction orders is deposited over the set of diffractive grating structures. As such, rather than refabricate a set of diffractive grating structures with modified parameters to compensate for inconsistencies, nonuniformities, and deformities caused by fabrication, only an optical material with an appropriate refractive index needs to be deposited over a set of diffractive grating structures to compensate for such inconsistencies, nonuniformities, and deformities, reducing the cost and time needed to fabricate the lightguide. Additionally, the same set of diffractive grating structures can be used for various applications as the deposited optical material rather than the parameters of the diffractive grating structures may be changed to meet the requirements of these applications. Because the same set of diffractive grating structures can be used for various applications, other sets of diffractive grating structures with different parameters do not also need to be fabricated, reducing the complexity and cost needed to fabricate lightguides for these applications. As an example, a deposited material's refractive index is enabled to be tuned to produce a uniform light extraction behavior based on the thickness of the lightguide, allowing lightguides of varying thicknesses to be supported by a single master stamp.

Further, to help increase the functionality of the lightguide, the optical material deposited on the set of grating structures includes a spatially varying refractive index. That is to say, the optical material includes two or more zones each including a corresponding portion of the optical material deposited over a respective number of diffractive grating structures and having a respective refractive index. As an example, an optical material includes a first zone having a first refractive index deposited over a first number of diffractive grating structures of a set of diffractive grating structures, a second zone having a second refractive index, different from the first refractive index, deposited over a second number of diffractive grating structures of the set of diffractive grating structures, and a third zone having a third refractive index, different from the first and second refractive indices, deposited over a third number of diffractive grating structures of the set of diffractive grating structures. In this way, each number of diffractive grating structures covered by a respective zone of optical material is configured to diffract different fractions of light into their diffraction orders. As such, diffractive grating structures with the same physical parameters may be used to perform a variety of applications, reducing the need to fabricate diffractive grating structures with different parameters and simplifying the fabrication process.

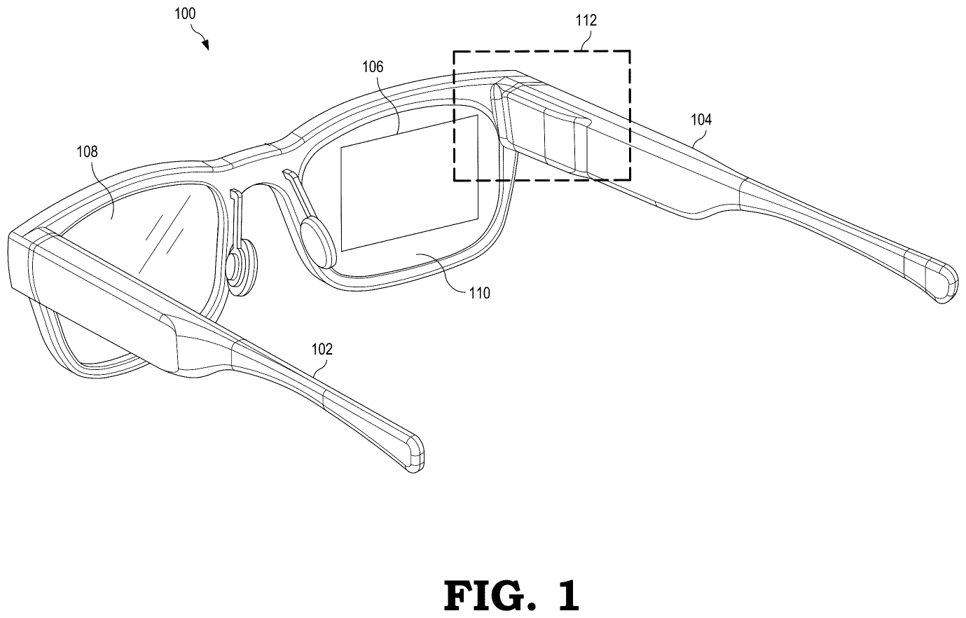

FIG. 1 illustrates an example display system 100 configured to direct light based on a deposited optical material, in accordance with embodiments. In embodiments, the display system 100 includes a support structure 102 having an arm 104, which houses a projection system configured to project XR images toward the eye of a user such that the user perceives the projected XR images as being displayed in a field of view (FOV) area 106 of a display at one or both of lens elements 108, 110. In the depicted embodiment, the display system 100 is an eyewear display that includes a support structure 102 configured to be worn on the head of a user and has a general shape and appearance of an eyeglasses (e.g., sunglasses) frame. The support structure 102 contains or otherwise includes various components to facilitate the projection of such images toward the eye of the user, such as a projector, an optical scanner, and a lightguide. In some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth (TM) interface, a Wi-Fi interface, and the like. Further, in some embodiments, the support structure 102 further includes one or more batteries or other portable power sources for supplying power to the electrical components of the display system 100. In some embodiments, some or all of these components of the display system 100 are fully or partially contained within an inner volume of support structure 102, such as within the arm 104 in region 112 of the support structure 102. It should be noted that while an example form factor is depicted, it will be appreciated that in other embodiments the display system 100 may have a different shape and appearance from the eyeglasses frame depicted in FIG. 1.

One or both of the lens elements 108, 110 are used by the display system 100 to provide an XR display in which rendered graphical content can be superimposed over or otherwise provided in conjunction with a real-world view as perceived by the user through the lens elements 108, 110. For example, light used to form a perceptible XR image or series of XR images may be projected by a projection system of the display system 100 onto the eye of the user via a series of optical path components, such as a lightguide formed at least partially in the corresponding lens element, one or more scan mirrors, one or more optical relays, one or more lenses (e.g., push lenses, pull lenses, curved lenses), or any combination thereof. In embodiments, one or both of the lens elements 108, 110 include at least a portion of a lightguide that routes display light received by an incoupler of the lightguide to an outcoupler of the lightguide, which outputs the display light toward an eye of a user of the display system 100. The display light is modulated and scanned onto the eye of the user such that the user perceives the display light as an image. In addition, each of the lens elements 108, 110 is sufficiently transparent to allow a user to see through the lens elements to provide a field of view of the user's real-world environment such that the XR image appears superimposed over at least a portion of the real-world environment.

In some embodiments, the projection system is a digital light processing-based projector, a microdisplay, a scanning laser projector, or any combination of a modulative light source such as a laser or one or more LEDs and a dynamic reflector mechanism such as one or more dynamic scanners or digital light processors. In some embodiments, the projection system includes multiple laser diodes (e.g., a red laser diode, a green laser diode, and/or a blue laser diode) and at least one scan mirror (e.g., two one-dimensional scan mirrors, which may be micro-electromechanical system (MEMS)-based or piezo-based). The projection system is communicatively coupled to the controller and a non-transitory processor-readable storage medium or memory storing processor-executable instructions and other data that, when executed by the controller, cause the controller to control the operation of the light engine. In some embodiments, the controller controls a scan area size and scan area location for the light engine and is communicatively coupled to a processor (not shown) that generates content to be displayed at the display system 100. The projection system scans light over a variable area, designated the FOV area 106, of the display system 100. The scan area size corresponds to the size of the FOV area 106 and the scan area location corresponds to a region of one of the lens elements 108, 110 at which the FOV area 106 is visible to the user. Generally, it is desirable for a display to have a wide FOV to accommodate the outcoupling of light across a wide range of angles. Herein, the range of different user eye positions that will be able to see the display is referred to as the eyebox of the display.

In some embodiments, display system 100 includes a lightguide configured to direct light based on a deposited optical material. For example, according to embodiments, the lightguide includes one or more incouplers, EPEs, outcouplers, or any combination thereof each formed from a respective set of diffraction grating structures disposed on a first surface of a substrate (e.g., glass substrate, plastic substrate) having opposing surfaces. Such diffraction grating structures, for example, each include structures formed from a material (e.g., glass, nanoimprint lithography (NIL) ultra-violet (UV) resin, NIL thermal resin) configured to direct light based on one or more parameters of the diffractive grating structures. That is to say, these diffraction grating structures diffract light in a dispersion pattern based on one or more parameters of the diffractive grating structures. Parameters of the diffractive grating structures include, for example, the angle of the diffractive grating structures relative to the surface of the substrate, the height of the diffractive grating structures, the period of the diffractive grating structures, the duty cycle of the diffractive grating structures, or any combination thereof. To help reduce the number of diffractive grating structures with different parameters needed to form the incouplers, EPEs, and outcouplers of the lightguide, the lightguide further includes one or more optical materials deposited on the first surface substrate such that each optical material encapsulates at least a portion of one or more diffractive grating structures of a set of diffractive grating structures. Each optical material, for example, includes a material having a refractive index such as silicon dioxide, plastic, glass, resin, polycarbonate, and the like. According to embodiments, the optical material encapsulating one or more diffractive grating structures is configured to diffract received light based on the refractive index of the optical material such that a uniform and efficient output coupling, pupil expansion, or incoupling takes place based on the role of the diffractive grating structures. In this way, diffractive grating structures having the same physical parameters are able to be modulated by the refractive index of the optical material encapsulating the diffractive grating structures, decreasing the complexity and cost needed to fabricate the lightguide.

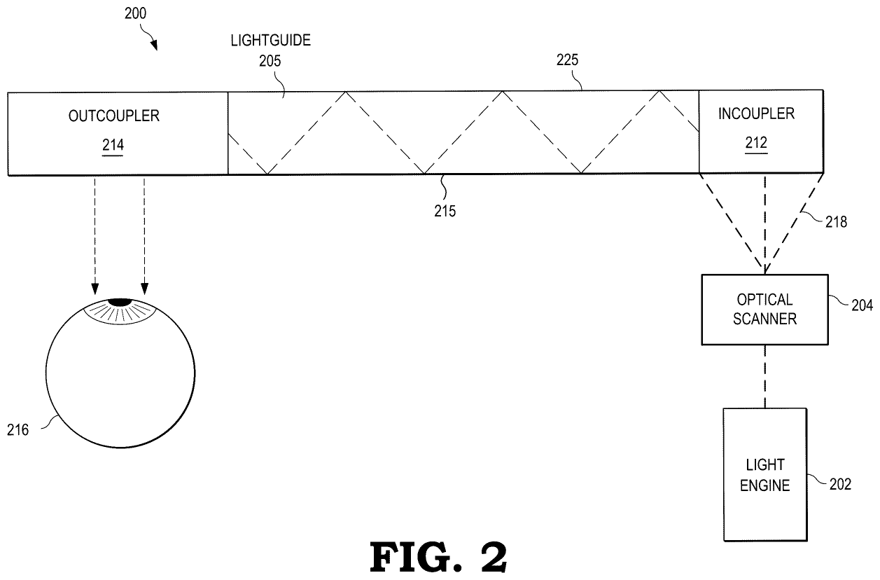

FIG. 2 illustrates a simplified block diagram of a projection system 200 that projects XR images directly onto the eye of a user using a lightguide configured to direct light based on a deposited optical material, in accordance with embodiments. The projection system 200 includes a light engine 202 and a lightguide 205. The lightguide 205 includes an incoupler 212 and an outcoupler 214, with the outcoupler 214 being optically aligned with an eye 216 of a user in the present example. In some embodiments, the projection system 200 is implemented in an HWD, such as the display system 100 of FIG. 1.

The light engine 202 includes one or more light sources configured to generate and output light 218 (e.g., visible laser light such as red, blue, and green laser light and/or non-visible laser light such as infrared laser light) representative of an XR image. In some embodiments, the light engine 202 is coupled to a driver or other controller (not shown), which controls the timing of emission of light from the light sources of the light engine 202 in accordance with instructions received by the controller or driver from a computer processor coupled thereto to modulate the light 218 to be perceived as images when output to the retina of an eye 216 of a user. For example, during the operation of the projection system 200, multiple laser light beams having respectively different wavelengths are output by the light sources of the light engine 202, then combined via a beam combiner (not shown), before being directed to the eye 216 of the user. The light engine 202 modulates the respective intensities of the light beams so that the combined light reflects a series of pixels of an XR image, with the particular intensity of each light beam at any given point in time contributing to the amount of corresponding color content and brightness in the pixel being represented by the combined light at that time.

In embodiments, the lightguide 205 of the projection system 200 has opposing surfaces (e.g., 215, 225) and includes the incoupler 212 and the outcoupler 214. The term “lightguide,” as used herein, will be understood to mean a combiner using one or more of TIR, PIR, specialized filters, and/or reflective surfaces, to transfer light from an incoupler (such as the incoupler 212) to an outcoupler (such as the outcoupler 214). In general, the terms “incoupler” and “outcoupler” will be understood to refer to a set of any type of optical structures formed on a surface (e.g., surface 215, surface 225) of the lightguide 205, and include, but are not limited to, diffraction grating structures, holograms, holographic optical elements (e.g., optical elements using one or more holograms), volume diffraction grating structures, volume holograms, surface relief diffraction grating structures, surface relief holograms, or any combination thereof. In some embodiments, a given incoupler 212 or outcoupler 214 is configured as a set of transmissive grating structures (e.g., transmissive diffraction grating structures or transmissive holographic grating structures), reflective grating structures (e.g., reflective diffraction grating structures or reflective holographic grating structures), or both that causes the incoupler 212 or outcoupler 214 to transmit light and to apply designed optical function(s) to the light during the transmission. According to some embodiments, the incoupler 212, the outcoupler 214, or both each include one or more diffractive grating structures encapsulated by one or more optical materials (e.g., silicon dioxide, plastic, glass, resin, polycarbonate) each having a respective refractive index. Such optical materials, for example, are configured to diffract received light based on the refractive index of the optical such that, for example, a set of diffractive gratings encapsulated by the optical material diffracts a fraction of light based on the refractive index in a corresponding diffraction pattern. As an example, an optical material diffracts received light based on the refractive index of the optical such that, for example, a set of diffractive gratings encapsulated by the optical material performs a uniform output coupling, pupil expansion, or incoupling based on the role of the diffractive grating structures. In this way, diffractive grating structures having the same parameters, (e.g., angle, height, duty cycle, period) are able to be modulated by the refractive index of the encapsulating optical material, decreasing the complexity and cost needed to fabricate the lightguide 205.

In the present example presented in FIG. 2, the display light 218 received at the incoupler 212 is relayed to the outcoupler 214 via the lightguide 205 using TIR, PIR, or both. The display light 218 is then output to the eye 216 of a user via the outcoupler 214. As described above, in some embodiments the lightguide 205 is implemented as part of an eyeglass lens, such as the lens element 108 or lens element 110 (e.g., FIG. 1) of the display system having an eyeglass form factor and employing the projection system 200. According to some embodiments, light engine 202 is configured to directly provide light 218 to the incoupler 212 of the lightguide 205 while in other embodiments, light engine 202 first provides light 218 to an optical scanner 204. The optical scanner 204 is configured to receive light 218 and scan light 218 in one or more directions toward incoupler 212 of lightguide 205. To this end, the optical scanner 204 includes one or more scan mirrors (e.g., MEMS mirrors) configured to scan received light in one or more directions (e.g., about one or more axes) and one or more optics relays configured to relay received light to a second point (e.g., incoupler 212). As an example, optical scanner 204 includes one or more MEMS mirrors that are driven by respective actuation voltages to oscillate in one or more directions (e.g., about one or more axes) during active operation of the projection system 200, causing the MEMS mirrors to scan the light 218 in one or more directions. Additionally, the optical scanner 204 includes one or more optical relays each including lenses, reflectors, or both configured to relay scanned light from a first scan mirror to a second scan mirror, relay scanned light from a scan mirror to incoupler 212, or both. For example, an optical relay includes a reflective relay, 2F relay, 4F relay, or any combination thereof configured to relay scanned light from a first scan mirror to a second scan mirror, incoupler 212, or both. In embodiments, an optical relay of the optical scanner 204 includes a line-scan relay configured to, for example, receive light scanned in one or more directions from a first scan mirror and relay the scanned light to a second scan mirror, the incoupler 212, or both such that the scanned light converges in the one or more directions to an exit pupil beyond the second scan mirror, the incoupler 212, or both. An exit pupil, for example, refers to the location along the optical path where beams of light intersect. According to embodiments, the width (e.g., smallest dimension) of a given exit pupil approximately corresponds to the diameter of the light 218 corresponding to that exit pupil.

In some embodiments, the light engine 202 includes an edge-emitting laser (EEL) that emits a light 218 having a substantially elliptical, non-circular cross-section, and the optical scanner includes 204 includes an optical relay configured to magnify or minimize the light 218 along its semi-major or semi-minor axis to circularize the light 218 prior to convergence of the light 218 on a scan mirror, incoupler 212, or both. In some such embodiments, a surface of a mirror plate of a scan mirror is elliptical and non-circular (e.g., similar in shape and size to the cross-sectional area of the light 218). In other such embodiments, the surface of the mirror plate of the scan mirror is circular.

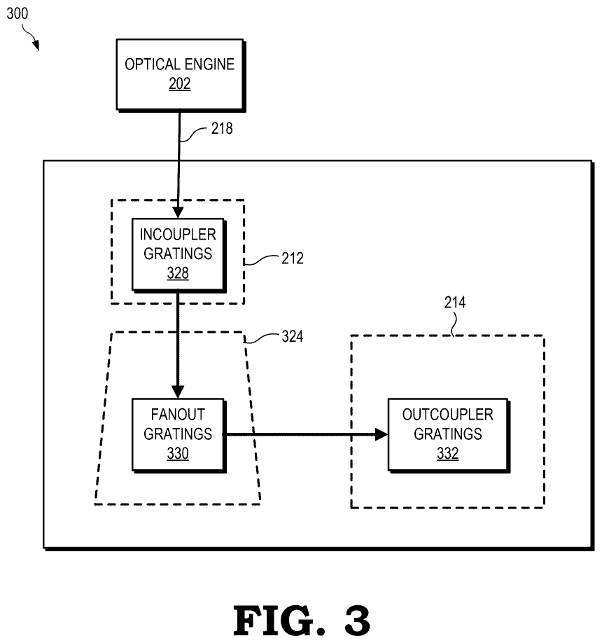

Although not shown in the example of FIG. 2, in some embodiments, additional optical components are included in any of the optical paths between the light engine 202 and the optical scanner 204, between the optical scanner 204 and the incoupler 212, between the incoupler 212 and the outcoupler 214, between the outcoupler 214 and the eye 216 (e.g., in order to shape the display light for viewing by the eye 216 of the user), or any combination thereof. In some embodiments, a prism is used to steer display light from the optical scanner 204 into the incoupler 212 so that display light is coupled into incoupler 212 at the appropriate angle to encourage the propagation of the display light in lightguide 205 by TIR. Also, in some embodiments, an exit pupil expander (EPE) (e.g., EPE 324 of FIG. 3, described below), such as a set of fold grating structures, is arranged in an intermediate stage between incoupler 212 and outcoupler 214 to receive display light that is coupled into lightguide 205 by the incoupler 212, expand the display light, and redirect the display light towards the outcoupler 214, where the outcoupler 214 then couples the display light out of lightguide 205 (e.g., toward the eye 216 of the user).

FIG. 3 illustrates a lightguide exit pupil expansion system 300, according to embodiments. In embodiments, lightguide exit pupil expansion system 300 is implemented in, for example, display system 100 and is configured to provide an XR image to an eye 216 of a user an HWD. To this end, lightguide exit pupil expansion system 300 includes light engine 202 and lightguide 205. According to embodiments, light engine 202 is configured to project light 218 (e.g., white light, green light, red light, blue light, infrared light, ultraviolet light, or any combination thereof) towards incoupler 212 of lightguide 205.

After receiving light 218, incoupler 212 is configured to guide light 218 from incoupler 212 to exit pupil expander (EPE) 324 via at least a portion of lightguide 205. For example, incoupler 212 guides light 218 from incoupler 212 such that light 218 propagates through at least a portion of lightguide 205 via TIR, PIR, or both and is received at EPE 324. To this end, incoupler 212 includes one or more incoupler gratings 328 each configured to diffract light 218 in a dispersion pattern such that light 218 is directed into a portion of the body of the lightguide 205. Such incoupler gratings 328, for example, include one or more diffractive grating structures (e.g., Bragg grating structures, surface-relief grating structures, polarization volume grating structures, volumetric holographic grating structures, mirrors, facets, mirror coatings) disposed on a surface 215, 225 of the lightguide 205 and configured to diffract received light based on one or more parameters of the incoupler gratings 328. These parameters of the incoupler gratings 328 include, for example, the angle of the incoupler gratings 328 relative to a surface 215, 225 of the lightguide, the height of the incoupler gratings 328, the duty cycle of the incoupler gratings 328, the period of the incoupler gratings 328, or any combination thereof. Additionally, in embodiments, incoupler gratings 328 include one or more optical materials (e.g., silicon dioxide, plastic, glass, resin, polycarbonate) deposited on a surface 215, 225 of the lightguide 205 such that each optical material encapsulates one or more diffractive grating structures of the incoupler gratings 328. Such optical materials, for example, are configured to diffract received light based on the refractive index of the optical material such that, for example, a set of diffractive gratings of incoupler gratings 328 encapsulated by the optical material diffracts a fraction of light 218 that is based on the refractive index of the optical materials encapsulating the set of diffractive gratings. As an example, an optical material diffracts light 218 based on the refractive index of the optical material such that a set of diffractive gratings of incoupler gratings 328 encapsulated by the optical material directs a fraction of light 218 based on the refractive index of the optical material in a dispersion pattern that causes the fraction of light 218 to propagate through the lightguide 205 via TIR, PIR, or both toward EPE 324.

In response to receiving light 218 from incoupler 212 (e.g., via at least a portion of lightguide 205), EPE 324 is configured to expand the eyebox of the display represented by light 218. For example, EPE 324 is configured to diffract light 218 such that the exit pupil of light 218 is enlarged (e.g., expanded). To expand the exit pupil of light 218, EPE 324 includes one or more fanout gratings 330 that are configured to diffract received light in a diffraction pattern so as to increase the size of the exit pupil of the light (e.g., expand the exit pupil of the light). Such fanout gratings 330, for example, include one or more diffractive grating structures (e.g., Bragg grating structures, surface-relief grating structures, polarization volume grating structures, volumetric holographic grating structures, mirrors, facets, mirror coatings) disposed on a surface 215, 225 of the lightguide 205 and configured to diffract received light based on one or more parameters of the fanout gratings 330. These parameters of the fanout gratings 330 include, for example, the angle of the fanout gratings 330 relative to a surface 215, 225 of the lightguide, the height of the fanout gratings 330, the duty cycle of the fanout gratings 330, the period of the fanout gratings 330, or any combination thereof. Additionally, in embodiments, fanout gratings 330 include one or more optical materials deposited on a surface 215, 225 of the lightguide 205 such that, for example, a set of diffractive gratings of fanout gratings 330 encapsulated by the optical material diffracts a fraction of light 218 that is based on the refractive index of the optical materials. As an example, an optical material diffracts light 218 from incoupler 212 based on the refractive index of the optical material such that a set of diffractive gratings of fanout gratings 330 encapsulated by the optical material directs a fraction of light 218 based on the refractive index of the optical material in a dispersion pattern that causes the fraction of light 218 to have an expanded exit pupil and to propagate through the lightguide 205 via TIR, PIR, or both toward outcoupler 214.

Outcoupler 214 is configured to direct received light 218 out of lightguide 205 and towards the eye 216 of a user. To this end, outcoupler 214 includes one or more outcoupler gratings 332 configured to diffract received light 218 such that light 218 is directed out of lightguide 205. Outcoupler gratings 332 includes, for example, one or more grating structures (e.g., Bragg grating structures, surface-relief grating structures, polarization volume grating structures, volumetric holographic grating structures, mirrors, facets, mirror coatings) and are configured to diffract received light based on one or more parameters (e.g., angle, height, period, duty cycle) of the outcoupler gratings 332. According to embodiments, outcoupler gratings 332 include one or more optical materials deposited on a surface 215, 225 of the lightguide 205 such that, for example, a set of diffractive gratings of outcoupler gratings 332 encapsulated by the optical materials diffracts a fraction of light 218 that is based on the refractive index of the optical materials. As an example, an optical material diffracts light 218 from EPE 324 based on the refractive index of the optical material such that a set of diffractive gratings of outcoupler gratings 332 encapsulated by the optical material directs a fraction of light 218 based on the refractive index of the optical material in a dispersion pattern that causes the fraction of light 218 to exit the lightguide 205 and be directed toward an eye 216 of the user.

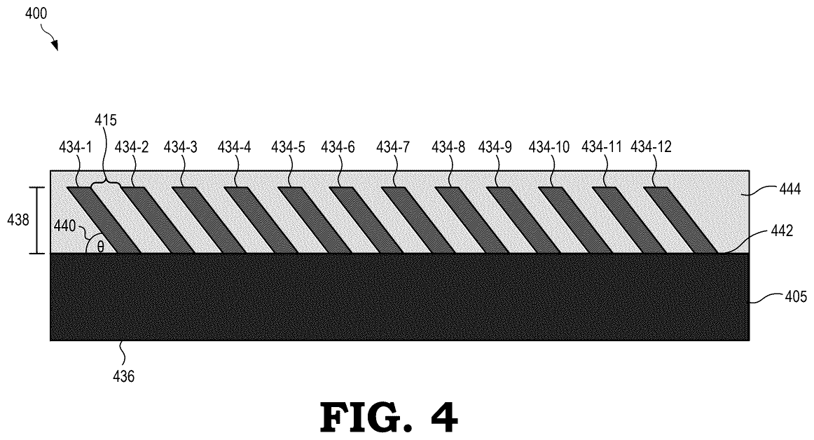

Referring now to FIG. 4, a lightguide 400 having a deposited optical material is presented, in accordance with embodiments. In embodiments, the lightguide 400 is implemented in projection system 200 as the lightguide 205. According to embodiments, the lightguide 400 includes a substrate 405 having a first surface (e.g., top surface) 442 and a second, opposite surface (e.g., bottom surface) 436. Substrate 405, for example, is formed from an effectively transparent material that allows a user to view a real-world space in front of the user such as glass or plastic. Further, the lightguide 400 includes one or more diffractive grating structures 434 formed on a surface (e.g., first surface 442) of the substrate 405. These diffractive grating structures 434, for example, are formed using lithography (e.g., gray-scale lithography, nanoimprint lithography), etching, trimming (e.g., laser trimming), soft working stamp fabrication, or any combination thereof and include materials such as glass, plastic, NIL ultra-violet UV resin, NIL thermal resin, and the like. According to embodiments, a set of diffractive grating structures 434 is configured to diffract received light such that the light is directed according to one or more functions of the lightguide 400 such as incoupler, exit pupil expansion, outcoupling, or any combination thereof. For example, a set of diffractive grating structures 434 diffracts received light in a diffraction pattern that causes the light to be directed according to one or more functions of the lightguide 400. In embodiments, a set of diffractive grating structures 434 is configured to diffract received light based on one or more parameters of the diffractive grating structures 434 in the set of diffractive grating structures. That is to say, a set of diffractive grating structures 434 is configured to direct received light in a direction based on one or more parameters of the diffractive grating structures 434 in the set of diffractive grating structures 434. These parameters include, for example, the angle 440 (e.g., 0) of the diffractive grating structures 434 relative to a surface (e.g., first surface 442) of the substrate 405, a height 438 of the diffractive grating structures 434, a duty cycle of the diffractive grating structures 434 (represented in FIG. 4 as the distance 415 between diffractive grating structures 434), a period of the diffractive grating structures 434, or any combination thereof. Though the example embodiment presented in FIG. 4 shows a set of diffractive grating structures including 12 diffractive grating structures (434-1, 434-2, 434-3, 434-4, 434-5, 434-6, 434-7, 434-8, 434-9, 434-10, 434-11, 434-12), in other embodiments, a set of diffractive grating structures can include any number of diffractive grating structures 434.

Additionally, in embodiments, lightguide 400 includes an optical material 444 deposited on a surface (e.g., surface 442) of the substrate 405 such that the optical material 444 at least partially encapsulates one or more diffractive grating structures 434. Such an optical material 444, for example, includes an effectively transparent material that allows a user to see a real-world space in front of the user such as silicon dioxide, plastic, glass, resin, polycarbonate, or the like. According to some embodiments, optical material 444 is deposited on a surface of the substrate 405 by spraying the optical material 444 by one or more nozzles onto the surface of the substrate 405. In embodiments, optical material 444 is configured to diffract received light (e.g., light 218) based on a refractive index of the optical material 444. For example, optical material 444 is configured to diffract received light such that a set of diffracting grating structures encapsulated by the optical material 444 diffracts a fraction of the light that is based on the refractive index of the optical material 444 in a dispersion pattern associated with the set of diffractive gratings. In this way, the set of diffractive grating structures is enabled to be modulated (e.g., the diffractive index of the set of diffractive grating structures is enabled to be modulated) by adjusting the refractive index of the optical material 444.

As an example, in embodiments, the optical material 444 is configured to diffract light such that a fraction of the light base on the refractive index of the optical material 444 is directed by one or more diffractive grating structures 434 encapsulated by the optical material 444 into a body of the lightguide 400 such that the light propagates via TIR, PIR, or both toward an EPE 324, outcoupler 214, or both. As another example, the optical material 444 is configured to diffract light such that a fraction of the light based on the refractive index of the optical material 444 is directed by one or more diffractive grating structures 434 encapsulated by the optical material 444 to expand an exit pupil of the fraction of the light and provide the fraction of the light with the expanded exit pupil to an outcoupler 214. As yet another example, the optical material 444 is configured to diffract light such that a fraction of the light based on the refractive index of the optical material 444 is directed by one or more diffractive grating structures 434 encapsulated by the optical material 444 out of the lightguide 400 and toward the eye 216 of a user.

Though the example embodiment presented in FIG. 4 shows the optical material 444 encapsulating 12 diffractive grating structures (434-1, 434-2, 434-3, 434-4, 434-5, 434-6, 434-7, 434-8, 434-9, 434-10, 434-11, 434-12), in other embodiments, the optical material 444 can encapsulate any number of diffractive grating structures 434.

Because the optical material 444 diffracts light (e.g., light 218) such that one or more diffractive gratings structures 434 direct a fraction of the light that is based on the refractive index of the optical material 444, the diffractive gratings structures 434 are enabled to be modified (e.g., a diffraction efficiency of the diffractive gratings structures 434 is enabled to be modified) without changing the parameters of the diffractive gratings structures 434. As such, in conditions where the diffraction efficiency of the diffractive grating structures 434 needs to be modified so as to compensate for deviations and deformities introduced into the lightguide 400 (e.g., introduced into the diffractive grating structures 434) during the manufacturing process, only the refractive index of the optical material 444 (e.g., only the optical material 444) needs to be modified rather than the parameters of the diffractive grating structures 434. Additionally, because the diffraction efficiency of the diffractive grating structures 434 is enabled to be modified by changing the refractive index of optical material 444, diffractive grating structures 434 having the same parameters are able to be used in different applications that require different diffraction efficiencies, such as in lightguides having varying thicknesses. As such, the cost and time needed to modify the diffraction efficiency of the diffractive grating structures 434 is reduced when compared to refabricating the diffractive grating structures 434 with modified parameters.

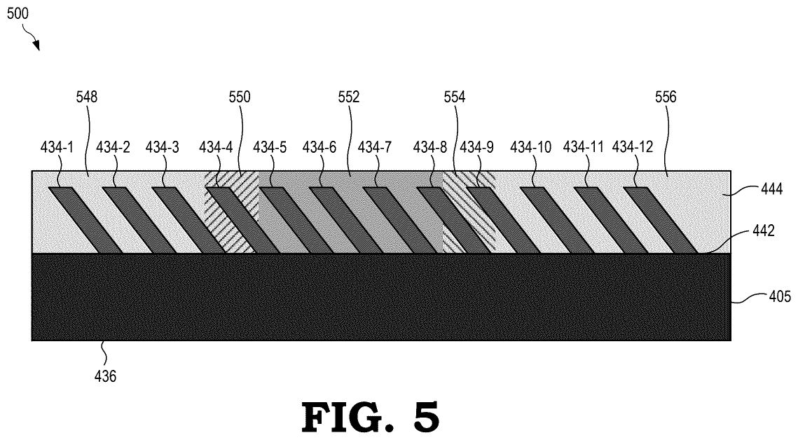

Referring now to FIG. 5, a lightguide 500 having zones of deposited optical material is presented, in accordance with embodiments. In embodiments, the lightguide 500 is implemented in projection system 200 as the lightguide 205. According to embodiments, the lightguide 500 includes an optical material 444 having two or more zones 548, 550, 552, 554, 556 deposited on a surface (e.g., surface 442) of substrate 405 such that one or more diffractive grating structures 434 are encapsulated by the optical material 444. Each zone 548 of the optical material 444, for example, includes a corresponding material with a respective refractive index. That is to say, each zone 548 of the optical material 444 has a corresponding refractive index. In embodiments, one or more zones 548, 550, 552, 554, 556 each have a refractive index that differs from the refractive index of one or more other zones 548, 550, 552, 554, 556, one or more zones 548, 550, 552, 554, 556 each have a refractive index that is the same as one or more other zones 548, 550, 552, 554, 556, or both. According to embodiments, each zone 548 is configured to encapsulate at least a portion of a respective number of diffractive grating structures 434. As an example, referring to the embodiment presented in FIG. 5, a first zone 548 having a first refractive index encapsulates at least a portion of diffractive grating structures 434-1, 434-2, and 434-3; a second zone 550 having a second refractive index encapsulates at least a portion of diffractive grating structures 434-3 and 434-4; a third zone 552 having a third refractive index encapsulates at least a portion of diffractive grating structures 434-4, 434-5, 434-6, 434-7, and 434-8; a fourth zone 554 having a fourth refractive index encapsulates at least a portion of diffractive grating structures 434-8 and 434-9; and a fifth zone 556 having a third refractive index encapsulates at least a portion of diffractive grating structures 434-9, 434-10, 434-11, and 434-12.

In embodiments, the diffractive grating structures 434 encapsulated by a respective zone 548, 550, 552, 554, 556, are together configured to direct a respective fraction of light that is based on the corresponding refractive index of the zone 548, 550, 552, 554, 556. For example, the diffractive grating structures 434-1, 434-2, and 434-3 are configured to direct a first fraction of light that is based on the refractive index of zone 548, and diffractive grating structures 434-5, 434-6, 434-7, and 434-8 are configured to direct a second fraction of light that is based on the refractive index of zone 552. In this way, different diffractive grating structures 434 having the same parameters in a set of diffractive grating structures 434 are enabled to perform different applications for the lightguide 500 that require, as an example, different diffractive efficiencies. For example, diffractive grating structures 434-1, 434-2, and 434-3 encapsulated by zone 548 are configured to diffract light at a first diffraction efficiency and diffractive grating structures 434-5, 434-6, 434-7, and 434-8 are configured to diffract light at a second, different, diffraction efficiency. As such, diffractive grating structures 434 with the same parameters are used for various applications of the lightguide 500, reducing the complexity needed to fabricate the lightguide 500.

According to embodiments, each zone 548, 550, 552, 554, 556 is deposited on a surface (e.g., surface 442) of substrate 405 by respective nozzles corresponding to respective locations on substrate 405. For example, a first zone 548 is deposited by one or more nozzles corresponding to the locations of diffractive grating structures 434-1, 434-2, and 434-3; a second zone 550 is deposited by one or more nozzles corresponding to the locations of diffractive grating structures 434-3 and 434-4; a third zone 552 is deposited by one or more nozzles corresponding to the locations of diffractive grating structures 434-4, 434-5, 434-6, 434-7, and 434-8; a fourth zone 554 is deposited by one or more nozzles corresponding to the locations of diffractive grating structures 434-8 and 434-9; and a fifth zone 556 is deposited by one or more nozzles corresponding to the locations of diffractive grating structures 434-9, 434-10, 434-11, and 434-12. As such, rather than fabricate new diffractive grating structures 434 with parameters that correspond to a desired function of the lightguide 500 to achieve the desired function, an optical material 444 with a corresponding refractive index is deposited on the diffractive grating structures 434 to achieve the desired function, reducing the time and cost of manufacturing. Further, in some embodiments, one or more zones 548, 550, 552, 554, 556 include a transition zone. Such transition zones, for example, include a mix of the optical materials 444 used in the zones 548, 550, 552, 554, 556 adjacent to the transition zone, a refractive index between the respective refractive indices of the zones 548, 550, 552, 554, 556 adjacent to the transition zone, or both. For example, according to some embodiments, zone 550 includes a mix of the optical material 444 used in zones 548, 552, a refractive index between the respective refractive indices of the zones 548, 552, or both. As another example, in some embodiments, zone 554 includes a mix of the optical material 444 used in zones 552, 556, a refractive index between the respective refractive indices of the zones 552, 556, or both. In embodiments, to achieve such transition zones, one or more nozzles corresponding to the location of the transition zone spray a mixture of the optical materials 444 used in the adjacent zones. Further, in other embodiments, one or more nozzles spraying a first optical material 444 for a first zone and one or more nozzles spraying a second optical material 444 for a second zone each also deposit their respective optical material 444 at a location on substrate 405 corresponding to the transition zone. Such transition zones, for example, allow the lightguide 500 to achieve additional functionalities such as further exit pupil expansion, FOV expansion, and the like.

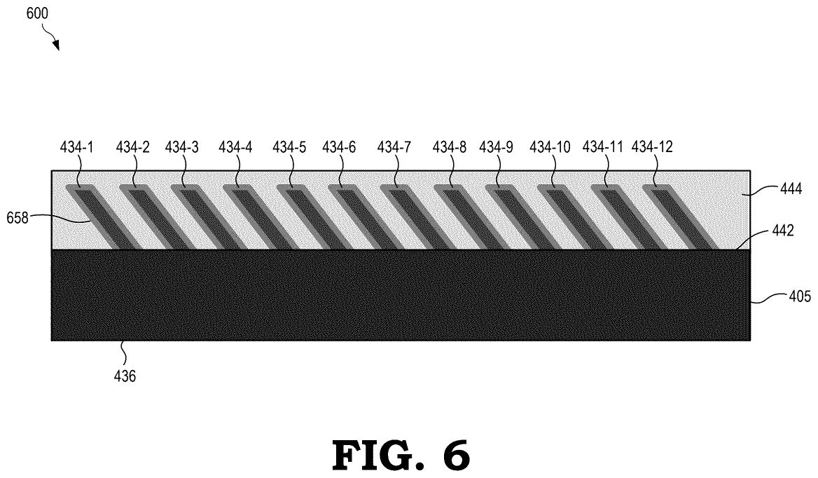

Referring now to FIG. 6, a diagram of a lightguide 600 having a set of diffractive grating structures with a deposited protective material and a deposited optical material is presented, in accordance with embodiments. In embodiments, the lightguide 600 is implemented in projection system 200 as the lightguide 205. According to embodiments, the lightguide 600 includes an optical material 444 deposited on a surface (e.g., surface 442) of substrate 405 such that one or more diffractive grating structures 434 are at least encapsulated by the optical material 444. Additionally, the lightguide 600 includes a protective material 658 deposited on one or more diffractive grating structures 434 such that the protective material covers at least a portion of the surfaces of the diffractive grating structures 434. Such a protective material 658, in some embodiments, is configured to improve adhesion of optical material 444 to one or more diffractive grating structures 434, avoid reactions between optical material 444 and the material of one or more diffractive grating structures 434 during fabrication, or both. Additionally, according to some embodiments, protective material 658 is configured to protect the diffractive grating structures 434 from damage caused by dust, dirt, water, fingers, the manufacturing process, or any combination thereof. To this end, the protective material 658 includes a transparent material that allows for the transmission of light such as films, plastics, resins, and the like. Though the example embodiment presented in FIG. 6 presents each diffractive grating structure 434 having protective material 658 deposited thereon, in other embodiments, any number of the diffractive grating structures 434 may have protective material 658 deposited thereon.

To deposit protective material 658 on the surfaces of one or more diffractive grating structures 434, the protective material 658 is first sprayed on, adhered to, pressed on, formed on, or any combination thereof the surfaces of one or more diffractive grating structures 434 such that the protective material 658 covers at least a portion of the surfaces of the diffractive grating structures 434. As an example, protective material 658 is deposited on the surfaces of one or more diffractive grating structures 434 via atomic layer deposition (ALD), physical vapor deposition (PVD), sputtering, and the like. After the protective material 658 has been deposited on the diffractive grating structures 434, the optical material 444 is then deposited on a surface of the substrate 405 such that the optical material 444 at least partially encapsulates the diffractive grating structures 434. For example, the optical material 444 is sprayed by one or more nozzles onto the surface of the substrate 405 such that the optical material 444 encapsulates the diffractive grating structures 434. In this way, the diffractive grating structures 434 then have a protective material 658 covering at least a portion of their surfaces and optical material 444 encapsulating the diffractive grating structures 434. Because of the protective material 658, the diffractive grating structures 434 are protected from external forces such as dust, dirt, water, fingers, and the like while also being protected during the deposit of optical material 444.

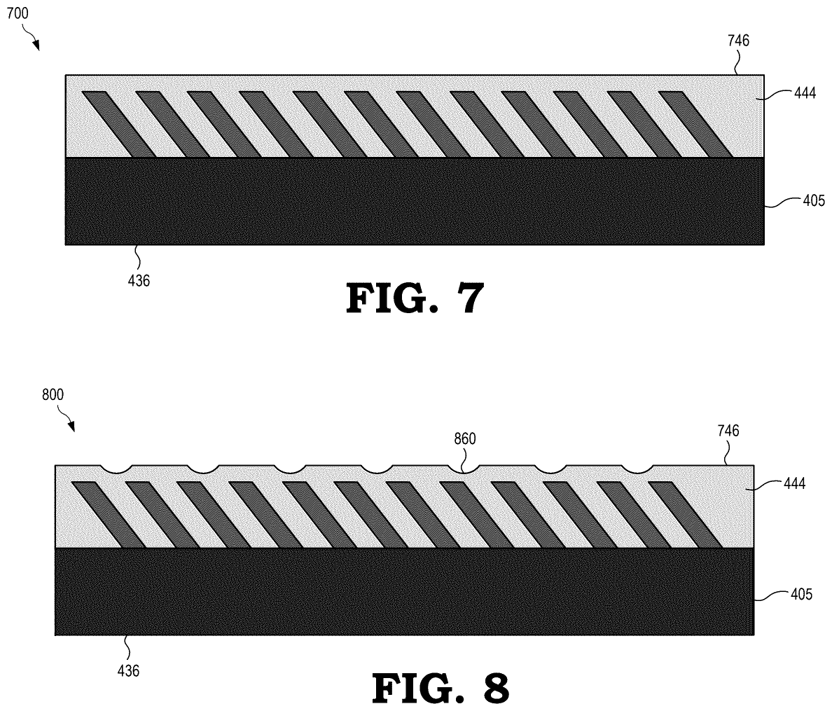

Referring now to FIG. 7, a lightguide 700 having a deposited optical material that forms a surface of the lightguide is presented, in accordance with some embodiments. In embodiments, the lightguide 700 is implemented in projection system 200 as the lightguide 205. According to embodiments, optical material 444 is deposited on a surface of substrate 405 such that optical material 444 forms a surface 746 (e.g., top surface) of the lightguide 700. To this end, a manufacturing process first deposits optical material 444 on a surface of substrate 405 such that optical material 444 encapsulates one or more diffractive grating structures 434. After the optical material 444 is deposited and cured, according to some embodiments, the manufacturing process includes removing at least a portion of the deposited optical material 444 via cutting, polishing, or both so as to form a surface 746 of the lightguide 700. Such a surface 746 includes a continuous planar surface or continuous non-planar surface (e.g., curved surface). For example, after the optical material 444 is deposited and cured, the optical material 444 is then cut so as to form a continuous planar surface or continuous non-planar (e.g., surface 746). As another example, after the optical material 444 is deposited and cured, the optical material 444 is then polished so as to form a continuous planar surface or continuous non-planar (e.g., surface 746).

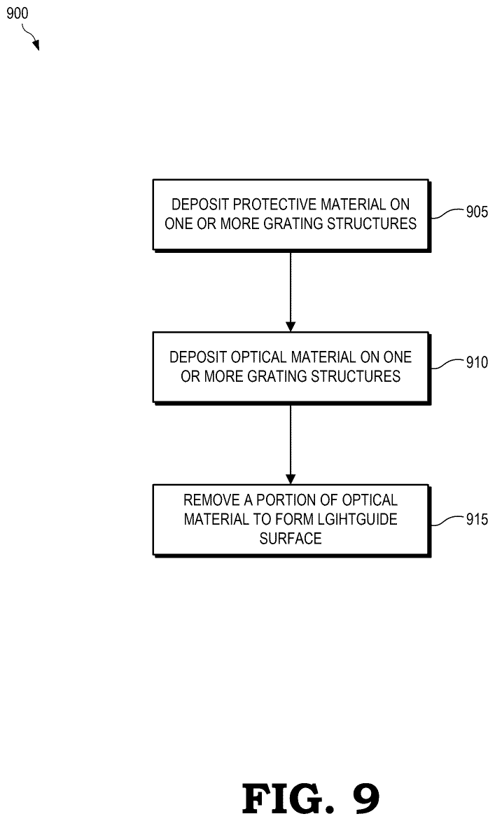

Referring now to FIG. 8, a lightguide 800 having a deposited optical material that forms a surface of the lightguide having one or more patterns is presented, in accordance with some embodiments. In embodiments, the lightguide 800 is implemented in projection system 200 as the lightguide 205. According to embodiments, optical material 444 is deposited on a surface of substrate 405 such that optical material 444 forms a surface 746 (e.g., top surface) of the lightguide 700 having one or more patterns 860. Such patterns 860, for example, include one or more depressions, raised sections, or both in the surface 746. Referring to the example embodiment presented in FIG. 8, a pattern 860 of surface 746 includes one or more depressions in the surface 746 such that surface 746 has a bumped appearance. To form a surface 746 having one or more patterns 860, a manufacturing process first deposits optical material 444 on a surface of substrate 405 such that optical material 444 encapsulates one or more diffractive grating structures 434. After the optical material 444 is deposited and cured, the manufacturing process includes removing at least a portion of the deposited optical material 444 via cutting, polishing, or both so as to form a surface 746 of the lightguide 800 with one or more patterns 860. For example, after the optical material 444 is deposited and cured, the optical material 444 is then cut, polished, or both so as to form a continuous planar surface or continuous non-planar (e.g., surface 746) having one or more patterns 860.

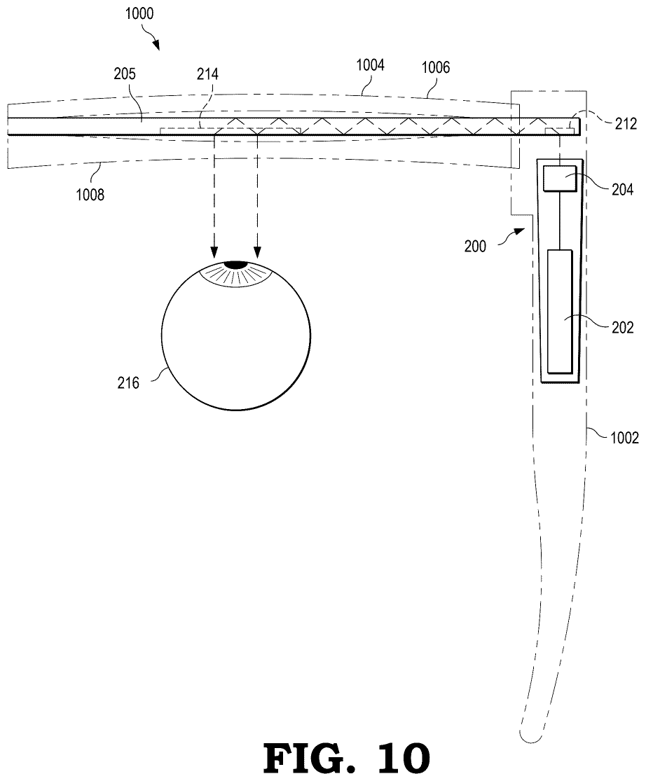

Referring now to FIG. 9, an example method 900 for manufacturing a lightguide having a deposited optical material is presented, in accordance with some embodiments. In embodiments, example method 900 is implemented to produce a lightguide such as lightguides 400, 500, 600, 700, and 800. According to embodiments, example method 900 first includes a substrate 405 having one or more diffractive grating structures 434 formed on a surface (e.g., surface 442) of substrate 405. Such diffractive grating structures 434 are formed on a surface of substrate 405 by, for example, lithography (e.g., gray-scale lithography, nanoimprint lithography), etching, trimming (e.g., laser trimming), soft working stamp fabrication, or any combination thereof. At block 905 of example method 900, a manufacturing system deposits protective material 658 onto one or more of the diffractive grating structures 434 such that the protective material 658 covers at least a portion of the surfaces of the diffractive grating structures 434. In embodiments, the manufacturing system deposits protective material 658 on one or more diffractive grating structures 434 by spraying the protective material 658, adhering the protective material 658, pressing the protective material 658, or any combination thereof, to name a few.

After the protective material 658 has been deposited and cured, at block 910, the manufacturing system then deposits one or more optical materials 444 onto a surface of substrate 405 such that the optical materials 444 each at least partially encapsulate one or more diffractive grating structures 434. As an example, one or more nozzles of the manufacturing system spray one or more optical materials 444 onto the surface of substrate 405 such that one or more diffractive grating structures 434 corresponding to the respective locations of the nozzles are encapsulated by a corresponding optical material 444. According to embodiments, the manufacturing system is configured to deposit one or more optical materials 444 on the surface of substrate 405 such that one or more zones 548, 550, 552, 554, 556, transition zones, or both are formed. These zones 548, 550, 552, 554, 556 and transition zones, for example, each at least partially encapsulate one or more diffractive grating structures 434. For example, the zones 548, 550, 552, 554, 556 and transition zones each encapsulate one or more diffractive grating structures 434 corresponding to the locations of the nozzles used to spray the optical material 444 for the zone 548, 550, 552, 554, 556 or transition zone. After the optical materials 444 have been deposited and cured, at block 915, in some embodiments, the manufacturing system removes at least a portion of the deposited optical materials 444 so as to form a surface 746 of a lightguide. For example, in some embodiments, the manufacturing system trims, polishes, or both the deposited optical materials 444 so as to form a planar or non-planar (e.g., curved) surface 746. As another example, the manufacturing system trims, polishes, or both the deposited optical materials 444 so as to form a planar or non-planar (e.g., curved) surface 746 having one or more patterns 860.

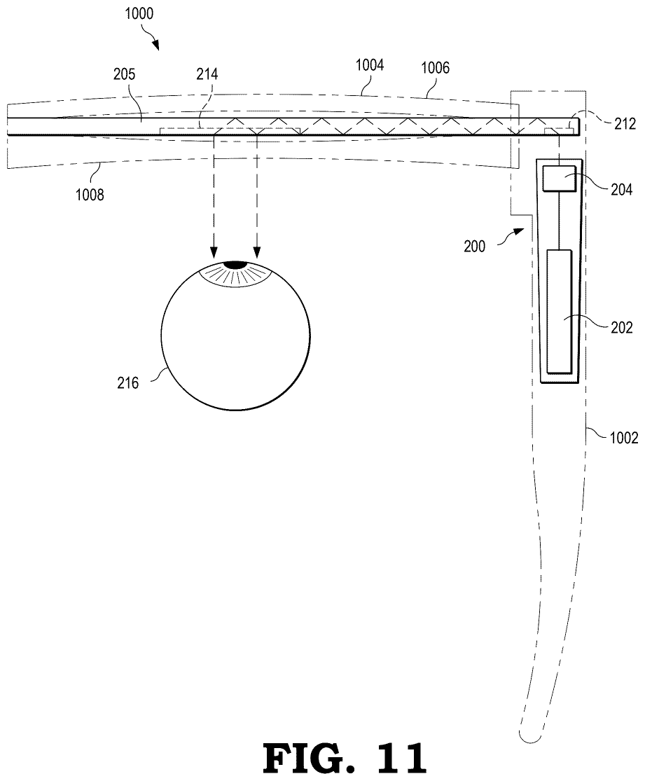

FIG. 10 illustrates a portion of an HMD 1000 that includes a lightguide configured to direct light based on a deposited optical material, in accordance with embodiments. For example, according to embodiments, HMD 1000 includes one or more lightguides such as lightguides 400, 500, 600, 700, and 800. In some embodiments, the HMD 1000 represents the display system 100 of FIG. 1. The light engine 202, optical scanner 204, and a portion of the lightguide 205 with incoupler 212 are included in an arm 1002 of the HMD 1100, in the present example. The HMD 1000 includes an optical combiner lens 1104 which includes a first lens 1106, a second lens 1108, and the lightguide 205, with the lightguide 205 disposed between the first lens 1106 and the second lens 1108. Display light 218 exiting through the outcoupler 214 travels through the second lens 1008 (which corresponds to, for example, the lens element 110 of the display system 100). In use, the light exiting second lens 1008 enters the pupil of an eye 222 of a user wearing the HMD 1000, causing the user to perceive a displayed image carried by the display light 218 output by one or more light engines 202.

According to embodiments, the optical combiner lens 1004 is substantially transparent, such that light from real-world spaces corresponding to the environment around the HMD 1000 passes through the first lens 1106, the second lens 1108, and the lightguide 205 to the eye 216 of the user. In this way, images, or other graphical content output by the projection system 200 are combined (e.g., overlayed) with real-world images of the user's environment when projected onto the eye 216 of the user to provide an AR experience to the user.

Although not shown in the depicted example, in some embodiments additional optical elements are included in any of the optical paths between the light engines 202 and the incoupler 212, in between the incoupler 212 and the outcoupler 214, in between the outcoupler 214 and the eye 216 of the user (e.g., in order to shape the display light for viewing by the eye 216 of the user), or any combination thereof. As an example, a prism is used to steer light from the optical scanner 204 into the incoupler 212 so that light is coupled into incoupler 212 at the appropriate angle to encourage propagation of the light in lightguide 205 by TIR. Also, in some embodiments, one or more exit pupil expanders (e.g., the EPE 324) including, for example, fanout gratings 330 are arranged in an intermediate stage between incoupler 212 and outcoupler 214 to receive light that is coupled into lightguide 205 by the incoupler 212, expand the light, and redirect the light towards the outcoupler 214 where the outcoupler 214 then couples the display light out of the lightguide 205 (e.g., toward the eye 216 of the user).

In some embodiments, certain aspects of the techniques described above may be implemented by one or more processors of a processing system executing software. The software comprises one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM), or other non-volatile memory device or devices, and the like. The executable instructions stored on the non-transitory computer-readable storage medium may be in source code, assembly language code, object code, or another instruction format that is interpreted or otherwise executable by one or more processors.

A computer-readable storage medium may include any storage medium, or combination of storage media, accessible by a computer system during use to provide instructions and/or data to the computer system. Such storage media can include but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A lightguide for a head-worn display, comprising:
a substrate having opposing surfaces;
a set of diffractive grating structures disposed on a surface of the substrate; and
an optical material having a refractive index deposited on the surface of the substrate such that a first diffractive grating structure of the set of diffractive grating structures is at least partially encapsulated by the optical material, wherein the first diffractive grating structure is configured to direct a fraction of the light that is based on the refractive index of the optical material.

2. The lightguide of claim 1, further comprising:
a second optical material having a second refractive index deposited on the surface of the substrate such that a second diffractive grating structure of the set of diffractive grating structures is at least partially encapsulated by the second optical material, wherein:
the second refractive index is different from the refractive index,
the second diffractive grating structure is different from the first diffractive grating structure, and
the second diffractive grating structure is configured to direct a second fraction of the light that is based on the second refractive index of the second optical material.

3. The lightguide of claim 2, further comprising:
a third optical material having a third refractive index deposited on the surface of the substrate such that the third optical material is between the optical material and the second optical material and the third optical material at least partially encapsulates a third diffractive grating structure of the set of diffractive grating structures, wherein:
the third refractive index is between the refractive index and the second refractive index,
the third diffractive grating structure is different from the first diffractive grating structure and the second diffractive grating structure, and
the third diffractive grating structure is configured to direct a third fraction of the light that is based on the third refractive index of the third optical material.

4. The lightguide of claim 1, further comprising:
a protective material deposited on at least a portion of the first diffractive grating structure.

5. The lightguide of claim 1, further comprising:
a planar surface formed by at least a portion of the optical material.

6. The lightguide of claim 5, wherein the planar surface includes a pattern.

7. The lightguide of claim 1, wherein the first diffractive grating structure forms at least a portion of an incoupler.

8. A method for manufacturing a lightguide for a head-worn display (HWD), comprising:
forming a set of diffractive grating structures on a surface of a substrate; and
depositing an optical material having a refractive index on the surface of the substrate such that a first diffractive grating structure of the set of diffractive grating structures is at least partially encapsulated by the optical material, wherein the first diffractive grating structure is configured to direct a fraction of the light that is based on the refractive index of the optical material.

9. The method of claim 8, further comprising:
depositing a second optical material having a second refractive index on the surface of the substrate such that a second diffractive grating structure of the set of diffractive grating structures is at least partially encapsulated by the second optical material, wherein:
the second refractive index is different from the refractive index,
the second diffractive grating structure is different from the first diffractive grating structure, and
the second diffractive grating structure is configured to direct a second fraction of the light that is based on the second refractive index of the second optical material.

10. The method of claim 9, further comprising:
depositing a third optical material having a third refractive index on the surface of the substrate such that the third optical material is between the optical material and the second optical material and the third optical material at least partially encapsulates a third diffractive grating structure of the set of diffractive grating structures, wherein:
the third refractive index is between the refractive index and the second refractive index,
the third diffractive grating structure is different from the first diffractive grating structure and the second diffractive grating structure, and
the third diffractive grating structure is configured to direct a third fraction of the light that is based on the third refractive index of the third optical material.

11. The method of claim 8, further comprising:
depositing a protective material on at least a portion of the first diffractive grating structure.

12. The method of claim 8, further comprising:
forming a non-planar surface of the lightguide by removing at least a portion of the optical material.

13. The method of claim 12, wherein the non-planar surface includes a pattern.

14. The method of claim 8, wherein the first diffractive grating structure forms at least a portion of an outcoupler.

15. A head-worn display (HWD) configured to display an extended reality (XR) image to a user, comprising:
a light engine configured to emit light representative of the XR image; and
a lightguide configured to receive the light representing of the XR from the light engine, the lightguide comprising:
a substrate having opposing surfaces;
a set of diffractive grating structures disposed on a surface of the substrate; and
an optical material having a refractive index deposited on the surface of the substrate such that a first diffractive grating structure of the set of diffractive grating structures is at least partially encapsulated by the optical material, wherein the first diffractive grating structure is configured to direct a fraction of the light representative of the XR image that is based on the refractive index of the optical material.

16. The HWD of claim 15, wherein the lightguide further comprises:
a second optical material having a second refractive index deposited on the surface of the substrate such that a second diffractive grating structure of the set of diffractive grating structures is at least partially encapsulated by the second optical material, wherein:
the second refractive index is different from the refractive index,
the second diffractive grating structure is different from the first diffractive grating structure, and
the second diffractive grating structure is configured to direct a second fraction of the light representative of the XR image that is based on the second refractive index of the second optical material.

17. The HWD of claim 16, wherein the lightguide further comprises:
a third optical material having a third refractive index deposited on the surface of the substrate such that the third optical material is between the optical material and the second optical material and the third optical material at least partially encapsulates a third diffractive grating structure of the set of diffractive grating structures, wherein:
the third refractive index is between the refractive index and the second refractive index,
the third diffractive grating structure is different from the first diffractive grating structure and the second diffractive grating structure, and
the third diffractive grating structure is configured to direct a third fraction of the light representative of the XR image that is based on the third refractive index of the third optical material.

18. The HWD of claim 15, wherein the lightguide further comprises a protective material deposited on at least a portion of the first diffractive grating structure.

19. The HWD of claim 15, wherein the lightguide includes a planar surface formed by at least a portion of the optical material.

20. The HWD of claim 15, wherein the first diffractive grating structure forms at least a portion of an incoupler of the lightguide.
